(19) United States
(12) Patent Application Publication
(10) Pub. No.: US 2002/0109883 A1
(43) Pub. Date: Aug. 15, 2002

(54) Method and apparatus for optical data transmission at high data rates with enhanced capacity using polarization multiplexing

(75) Inventors: Marcel F.C. Schemmann, Maria-Hoop (NL); Zoran Maricevic, Manlius, NY (US)

Correspondence Address: KENYON & KENYON, ONE BROADWAY, NEW YORK, NY, 10004, US

(73) Assignee: Teradvance communications, LLC

(21) Appl. No.: 09/782,354

(22) Filed: Feb. 12, 2001

(51) Int. Cl. H04B 10/00; H04B 10/06

(52) U.S. Cl. 359/156; 359/189

(57) ABSTRACT

A system and method for enhancing data capacity in optical data communication are described. First data is modulated onto a first optical carrier to occupy a data frequency range. The first optical carrier includes a first side frequency separated from the frequency range of the data band. A first modulated carrier having a first polarization state is output. Second data is modulated onto a second optical carrier signal occupying the same data frequency range. The second optical carrier includes a second side frequency separated from the data frequency range of the data band in a direction opposite from the first side frequency. A second modulated carrier having a first polarization state is output. The polarization state of the second modulated carrier is changed to a second polarization state orthogonal to the first polarization state and the first modulated carrier is combined with the second modulated carrier into a combined carrier. The combined carrier is optically transmitted to a receiver, in which the first data having the first polarization state is extracted from the second data having the second polarization state.

### CROSS-REFERENCES TO RELATED APPLICATIONS

This application is related to copending and commonly assigned U.S. patent application Ser. No. 09/748,750, filed in the United States Patent and Trademark office on Dec. 26, 2000, entitled “Method, System and Apparatus for Optically Transferring Information”.

### FIELD OF THE INVENTION

The present invention relates to optical data communication, and in particular, relates to a method and apparatus used to enhance data rate capacity using polarization multiplexing.

### BACKGROUND INFORMATION

Due to increased demand for data transport capacity in recent years, systems have been developed that transport OC-192 (9.95 Gbp/s) or similar data formats over standard single mode fiber. The inherent properties of single mode fiber are such that the data transport distance for the OC-192 standard 9.95 Gbp/s rate is limited to approximately 65 km due to dispersion. Newer fibers, such as Corning's Non-zero Dispersion Shifted (NZ-DSF) LEAF™ fibers and Lucent's True-Wave™ NZ-DSF fibers have been developed to extend the transport distance further, making optical fiber a more attractive medium for data communication.

Advancements in optical signal processing techniques that increase data capacity on optical fiber have also taken place. Dense-Wavelength-Division-Multiplexing (DWDM) systems have been developed that carry many different carrier wavelengths of radiation on a single fiber with each carrier wavelength modulated to carry a high data rate signal. As data rate requirements continue to grow, the capacity enhancements of DWDM will need to be extended by techniques that increase optical data transmission capacity per wavelength carried but that avoid fiber dispersion effects which deteriorate transmission at higher frequencies.

### SUMMARY OF THE INVENTION

To enhance the optical transmission data capacity, the present invention provides an optical data signal transmitter that includes at least one optical carrier generator which generates an optical carrier signal having two side frequencies derived from a source frequency. The transmitter also includes at least one data modulator for modulating data onto the at least one optical carrier signal, creating at least one optical data signal which has a first polarization state. At least one polarization transformer is used to encode a portion of the modulated data and a first of the two side frequencies of the at least one optical data signal with a second polarization state. The second polarization state is orthogonal to the first polarization state, allowing first data having a first polarization state and second data having a second polarization state to occupy the same frequency range.

In a first embodiment of the transmitter according to the present invention, the at least one data modulator modulates data onto information bands, each information band centered at one of the two side frequencies of the at least one optical carrier signal respectively. In a second embodiment of the transmitter according to the present invention, the at least one optical carrier generator produces an optical carrier signal that includes the source frequency and the at least one data modulator imprints data onto an information band centered at the source frequency. In both the first and second embodiment, data is imprinted onto the optical data carrier in quadrature to enhance the data-carrying capacity of the optical data carrier signal.

The present invention also provides a method of increasing the data capacity of optical transmission. At least one optical carrier signal is generated, each signal having two side frequencies derived from a source frequency. Data is modulated onto the at least one optical carrier signal, creating at least one optical data signal in a first polarization state. A portion of the modulated data and a first of the two side frequencies of the at least one optical data signal is encoded with a second polarization state, the second polarization state being orthogonal to the first polarization state.

An optical receiver is also provided which includes an optical splitter for splitting an incoming optical data signal into a first optical data sub-signal and a second optical data sub-signal. Each of the sub-signals include a first side carrier frequency having a first polarization state, a second side carrier frequency having a second polarization state, and a central information band. The central information band contains first data having the first polarization state and second data having the second polarization state. The optical receiver also includes a frequency differentiator which acts on the first and second optical data sub-signals differently, enabling the first side carrier frequency and the first data to be separated from the second side carrier frequency and the second data.

In a first embodiment of the receiver according to the present invention, the frequency differentiator separates the data having the first polarization state from the data having the second polarization state in the radio frequency domain, while in the second embodiment, the extraction and separation of data in the two polarization states occurs in the optical domain. In the first embodiment of the receiver, when a signal is received from a transmitter according to the invention, it is split into two branches. In one branch, the phase of one of one of the side carrier is shifted, the resulting signal is downconverted to the radio frequency domain, and then input to a hybrid coupler which creates sum and difference products which separate the first data in the first polarization state from the second data in the second polarization state. In the second embodiment of the receiver, the first and second side carriers are filtered in respective optical filters. The remaining unfiltered first side carrier is used to extract the first data and the second unfiltered side carrier is used to extract the second data.

The present invention also provides an optical data communication system. The system comprises a transmitter which further includes at least one optical carrier generator, each generating an optical carrier signal having two side frequencies derived from a source frequency. The transmitter also includes at least one data modulator for modulating data onto the optical carrier signal. The at least one data modulator outputs at least one optical data signal having a first polarization state. The at least one optical data signal is input to at least one polarization transformer for encoding a portion of the modulated data and a first of the two side frequencies with a second polarization state, the second polarization state being orthogonal to the first polarization state. The transmitter sends the at least one optical data signal through an optical fiber. The at least one optical data signal is then received at an optical receiver.

A method for enhancing data capacity in optical data communication is further disclosed. The method comprises modulating first data onto a first optical carrier to occupy a data frequency range. The first optical carrier includes a first side frequency separated from the frequency range of the data band. A first modulated carrier having a first polarization state is output. The method further comprises modulating second data onto a second optical carrier to occupy same data frequency range. The second optical carrier includes a second side frequency separated from the data frequency range of the data band in a direction opposite from the first side frequency. A second modulated carrier having a first polarization state is output. The polarization state of the second modulated carrier is changed to a second polarization state orthogonal to the first polarization state and the first modulated carrier is combined with the second modulated carrier into a combined carrier. The combined carrier is optically transmitted to a receiver, in which the first data having the first polarization state is extracted from the second data having the second polarization state.

### BRIEF DESCRIPTION OF THE DRAWINGS

FIG. 1 is a block diagram of a transmitter according to an embodiment of the present invention.

FIG. 2a shows the spectrum of an optical carrier signal at the output of CMB1 of FIG. 1 according to an embodiment of the present invention.

FIG. 2b shows the spectrum of an optical data signal at the output of CMB2 of FIG. 1 after data modulation in quadrature according to an embodiment of the present invention.

FIG. 2c shows the spectrum of an optical data signal at the output of CMB3 of FIG. 1 according to an embodiment of the present invention.

FIG. 2d shows the spectrum of an optical data signal out the output of CMB4 of FIG. 1 after the addition of the original source signal.

FIG. 2e shows the spectrum of an optical data signal at the output of CMB5 of FIG. 1 after the addition of the original source signal.

FIG. 3 shows spectra of optical data signals at the outputs of CMB9 and CMB10 of FIG. 1 according to an embodiment of the present invention.

FIG. 4a shows the spectrum of an optical data signal at the output of CMB14 of FIG. 1 and the bands rejected by the optical multiplexer OM of FIG. 1 according to an embodiment of the present invention.

FIG. 4b shows the spectrum of an optical data signal at the output of optical multiplexer OM of FIG. 1 according to an embodiment of the present invention.

FIG. 5 is a block diagram of a transmitter according to an alternative embodiment of the present invention.

FIG. 6 shows the spectrum of an optical data signal at the output of CMB7 of FIG. 5 according to an embodiment of the present invention.

FIG. 7a is a block diagram of a receiver according to an embodiment of the present invention.

FIG. 7b is a block diagram of a receiver according to an alternative embodiment of the present invention.

FIG. 8 shows spectra of optical data signals at the outputs of OF11 and OF12 of FIG. 7b according to an embodiment of the present invention.

FIG. 9 shows a flow chart of the method of increasing the data capacity of optical transmission according to an embodiment of the present invention.

### DETAILED DESCRIPTION

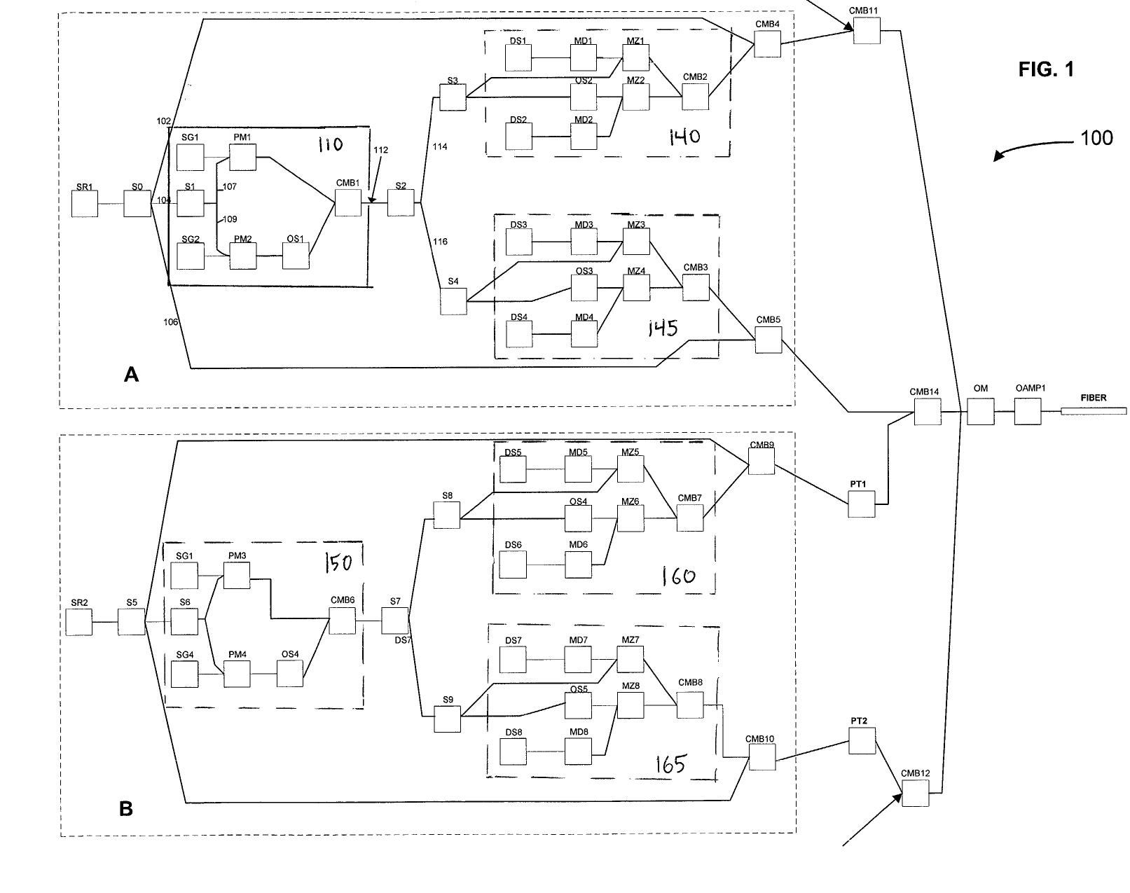

FIG. 1 shows an embodiment of a transmitter according to the present invention. As shown, the transmitter includes two identical component blocks, A and B. Referring to block A, block SR1 is a signal radiation source for generating coherent light, and may be implemented, for example, as a laser diode. The light radiated from source SR1 may be in the visible or infrared spectrum. Source SR1 transmits radiation having a frequency f_{SR1-A} to splitter S0, which splits the light into three radiation signals 102, 104, and 106. The radiation is polarized in a single direction, denoted x-polarization. Signals 102 and 106 are transmitted to combiners CMB4 and CMB5 and signal 104 is transmitted to splitter S1 of optical carrier generator 110, which may be implemented using a Mach-Zehnder interferometer.

Optical carrier generator 110 generates (in Step 300 of FIG. 9) an optical carrier signal having two side frequencies as described below. Splitter S1 further splits radiation signal 104 into signals 107 and 109, transmitted to phase modulators PM1 and PM2 of the optical carrier generator 110 respectively. Each of modulators PM1 and PM2 receives a radio frequency (RF) electrical signal from respective RF signal generators SG1 and SG2, which are equal in amplitude and opposite in phase. In an embodiment, RF signal generators SG1 and SG2 of optical carrier generator 110 transmit 15 or 30 GHz signals of equal amplitude to the respective modulators. Using the input RF signals, each phase modulator PM1, PM2 outputs a carrier, with one carrier spaced above or below f_{SR1-A} and another carrier spaced below f_{SR1-A} by the amount of the modulation frequency and multiples of the modulation frequency.

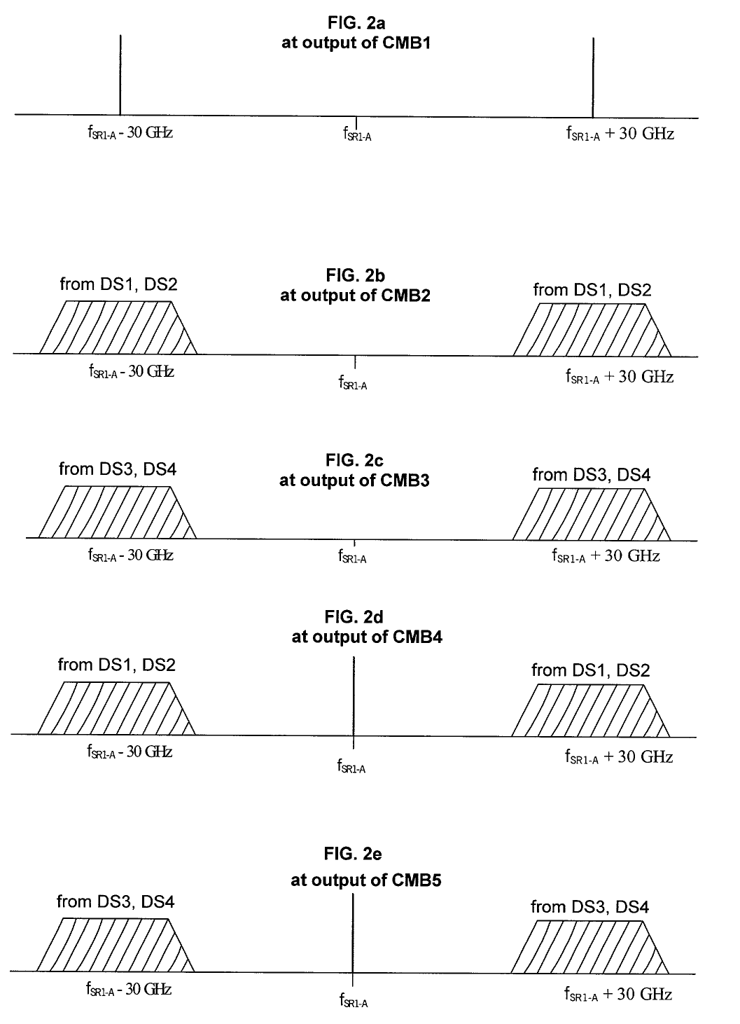

The output of modulator PM2 is input to an optical phase shifter OS1. In alternative implementations, the optical phase shifter OS1 performs a 0 or a 180 degree phase shift, alternatively, on the input signal. A zero degree phase shift cancels odd order harmonics and a 180 degree phase shift cancels even order harmonics. In an embodiment of the present invention, an optical carrier signal is generated in which the side carriers are spaced approximately 30 GHz from f_{SR1-A} owing to bandwidth and reception considerations According to this embodiment, SG1 and SG2 generate 15 GHz signals, and the optical phase shifter OS1 produces a zero degree shift so that a 30 GHz even order second harmonic is created and odd order harmonics are canceled. Signals from modulator PM1 and phase shifter OS1 are input to optical combiner CMB1, the last stage of the optical carrier generator 110, which combines the signals and outputs a carrier signal 112 that contains the frequencies 30 GHz above and below the original source frequency f_{SR1-A}. The spectrum of carrier signal 112 is shown in FIG. 2a.

At splitter S2, the output carrier signal 112 is split into two branches 114, 116. Each branch is further split in sub-branches at splitters S3 and S4. The sub-branches output from splitter S3 are input to an upper data modulator 140 and the sub-branches output from splitter S4 are input to a lower data modulator 145. Each data modulator 140, 145 modulates or imprints data onto the optical carrier signal (Step 310 of FIG. 9). A first sub-branch signal from S3 is input to Mach-Zehnder interferometer MZ1 of data modulator 140, which also receives an input data signal from a modulator driver MD1 that in turn receives a 10 Gbp/s data signal from digital signal generator DS1. The modulator driver MD1 may be implemented as an oscillator, for example. The interferometer MZ1 acts as an amplitude modulator and imprints the input data signal onto the spectrum of the optical carrier signal. The second sub-branch signal from S3 is input to an optical shifter OS2 which shifts the carrier signal 90 degrees in phase. The output from OS2 is transmitted to an interferometer MZ2, where a similar data modulation takes place (using a 10 Gbp/s data signal from data signal generator DS2). Due to the phase shifting of the second sub-branch by OS2, the two data modulations at MZ1 and MZ2 are performed on carrier signals that are 90 degrees out of phase with respect to each other, and therefore in quadrature. When the output from MZ1 and MZ2 are combined in CMB2, the two data-modulated carriers do not interfere because of their orthogonal phase relationship. Therefore, two data signals from DS1 and DS2 are able to occupy the same spectral region, doubling data capacity to 20 Gbp/s. This spectrum of the output from CMB2 is shown in FIG. 2b. The shaded regions represent areas of the spectrum carrying data, denoted as data bands. The regions extend an octave of 20 GHz, centered on f_{SR1-A} +/−30 GHz with respect to f_{SR1-A}.

The branch 116 of the optical carrier from splitter S2 that is further split into sub-branches at S4 is transmitted to analogous elements MZ3, OS3 and MZ4 of the lower data modulator 145, and modulated in quadrature by data signals from signal generators DS3 and DS4. The modulated sub-branches are combined at CMB3 of data modulator 145. The spectrum of radiation at the output of CMB3 is shown in FIG. 2c. As can be discerned, the spectrum matches the spectrum from CMB2 shown in FIG. 2b, the difference being that the shaded side carrier regions at −30 GHz and +30 GHz relative to f_{SR1-A} in FIG. 2c carry a 20 Gbp/s data signal in quadrature from DS3 and DS4 rather than DS1 and DS2. The modulated optical carriers at the outputs of CMB2 and CMB3 are combined with the original source signal at combiners CMB4 and CMB5, respectively. The spectra at the outputs of CMB4 and CMB5 are shown in FIGS. 2d and 2e, respectively. Each of the spectra in FIGS. 2d and 2e show the 20 GHz-wide data bands combined with the single reference frequency f_{SR1-A}.

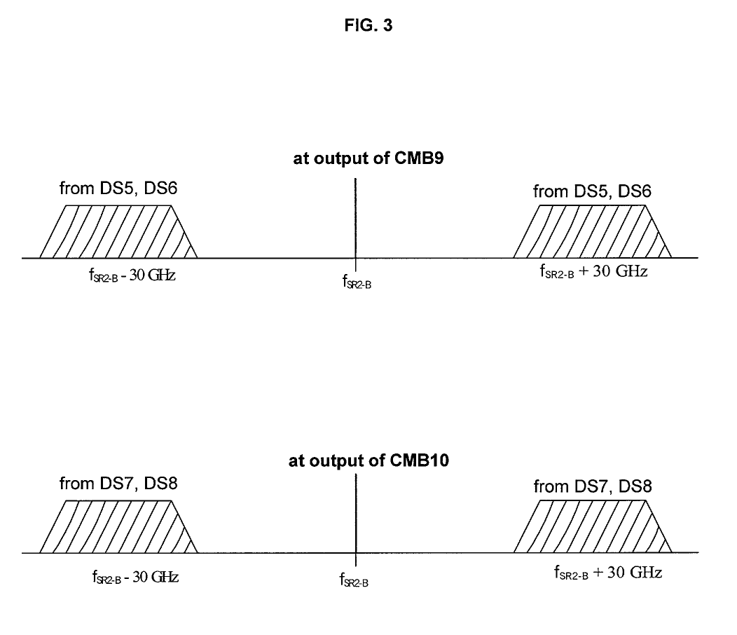

In block B of FIG. 1, a signal radiation source SR2, having the same polarization (x-polarization) as source SR1, transmits coherent radiation to a splitter S5. The frequency of radiation from SR2 f_{SR2-B} is 50 to 60 GHz from the frequency of the source radiation in block A, F_{SR1-A}. From source SR2, radiation is transmitted to components that are analogous to those described above with respect to block A. The source is initially split, an optical carrier signal including two side frequencies is generated at optical carrier generator 150, split and then modulated by data signals DS5, DS6 in second upper data modulator 160 and by DS7, DS8 in second lower data modulator 165. The optical data signals in quadrature are combined in combiner CMB7 of data modulator 160 and in CMB8 of data modulator 165. The signals output from combiners CMB7 and CMB8 are then combined with the source signal in respective combiners CMB9 and CMB10. FIG. 3 shows the outputs of combiners CMB9 and CMB10. These spectra are similar to the spectra at outputs of combiners CMB4 and CMB5 shown in FIGS. 2d and 2e. Both show data spread over 20 GHz centered 30 GHz above and below a central frequency. All of the spectra are in x-polarization.

CMB5, which receives the output of data modulator 145 in block A transmits an output signal to combiner CMB14. The output of CMB9 of block B is input to a polarization transformer PT1, before being combined with the output of CMB5 at CMB14. The functionality of the combiner CMB14 and the polarization transformer PT1 can also be implemented in a single polarization combiner component. The polarization transformer PT1 rotates the polarization of the input signal 90 degrees, from x-polarization to y-polarization, thereby encoding the input with a y-polarization (Step 320 of FIG. 9). The output of combiner CMB4 at the upper branch of block A is passed on to a combiner CMB11 which also receives input from another transmitter block which is not shown. Blocks A and B may be replicated in a series of adjacent transmission channels above and below transmitter 100 in a dense wavelength division multiplexing scheme. In this scheme, combiner CMB11 would receive an output from a polarization transformer in a transmitter block above Block A corresponding to the output from polarization transformer PT2 shown in the lower portion of block B described as follows. The output of combiner CMB10 in block B is passed to the polarization transformer PT2, where the polarization of the output signal is transformed to y-polarization and then transmitted to combiner CMB12, which receives input from a combiner corresponding to combiner CMB4 of Block A output from a further transmitter block below Block B, not shown.

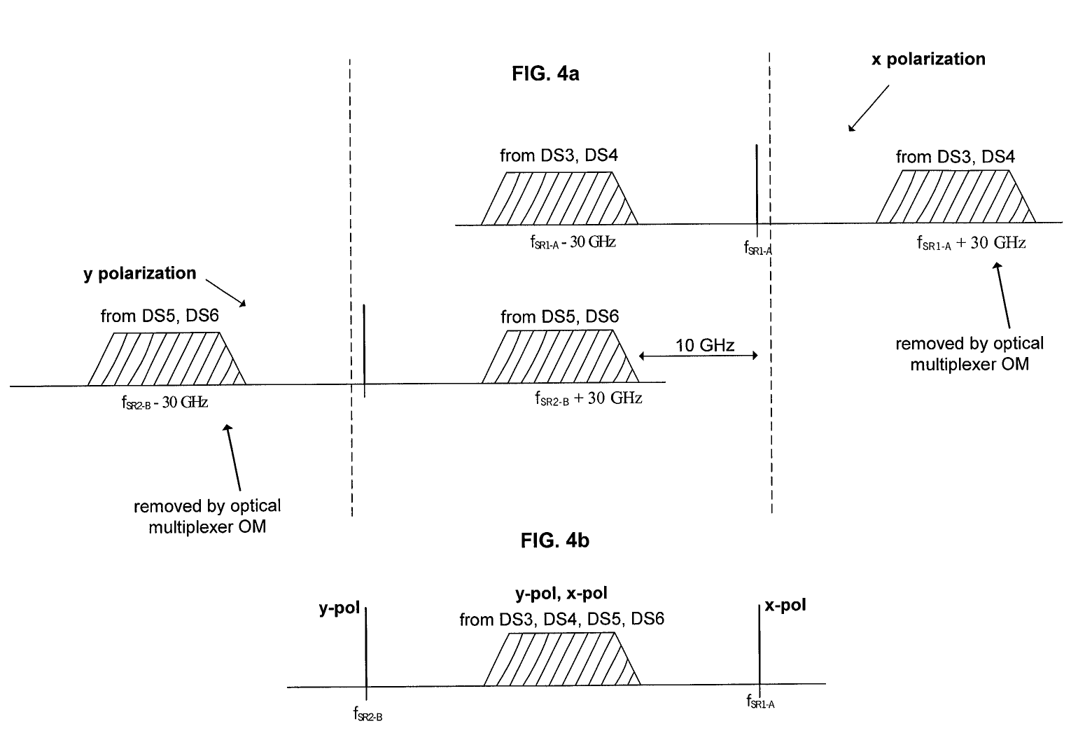

Combiner CMB14 receives the output of CMB5 in x-polarization and the output of PT1 (from CMB9) in y-polarization. The output from CMB14 is shown in FIG. 4a. Source frequencies f_{SR1-A} and f_{SR2-B} are set 50-60 GHz apart from one another. In the figure, for purposes of illustration f_{SR1-A} is shown to be 50-60 GHz above f_{SR2-B} although the reverse, with f_{SR2-B} being above f_{SR1-A} is also possible. The combined signal is transmitted to one input channel of optical multiplexer OM. The optical multiplexer is a passive component that is typically used in wavelength division multiplexing systems. The OM has multiple inputs of which three are shown having connections in FIG. 1. Besides the input from CMB14, the next upper and lower input channel of the OM receives the combined outputs of CMB11 and CMB12, respectively. The optical multiplexer OM has specific channels which include passband filters. The filters of a specific channel receive the output of combiner CMB14 and reject part of the information bands output from CMB14. FIG. 4a indicates the bands that are rejected in the particular input channel of optical multiplexer OM which receives the output of combiner CMB14. However, the bands that are finally rejected in the particular input channel are first combined with the outputs of other transmitter blocks in CMB11 and CMB12, as discussed above, and then to input to other channels of the optical multiplexer OM, where they are passed.

FIG. 4a shows the spectral bands passed by one channel of the OM: the information band centered −30 GHz with respect to f_{SR1-A} and the band centered +30 GHz with respect to f_{SR2-B}. As shown in the figure, the passed information bands occupy approximately the same frequency region, with a tolerance of up to 10 GHz because the central frequencies f_{SR1-A} and f_{SR2-B}, as noted above, do not need to be precisely 60 GHz apart from one another, but can be as little as 50 GHz apart, 50 GHz being a commonly used spacing in dense wavelength division multiplexing. While the information bands overlap in frequency, they do not affect each other because they have orthogonal x and y polarization. This allows a further doubling of data carrying capacity to 40 Gbp/s since each of the two bands passed by a particular OM channel carry 20 Gbp/s. FIG. 4b shows the final output spectrum of the particular OM channel, including the information-carrying bands and the polarizations associated with each part of the spectrum. The output includes the data signal band having both x and y polarized parts, a side carrier at F_{SR1-A} having x polarization, and a side carrier at f_{SR2-B} having y polarization. This output of the optical multiplexer OM is transmitted to an optical amplifier OAMP1, which amplifies the whole optical spectrum including side carrier frequencies of the signal and the data signal in preparation for transmission over a long-haul optical fiber.

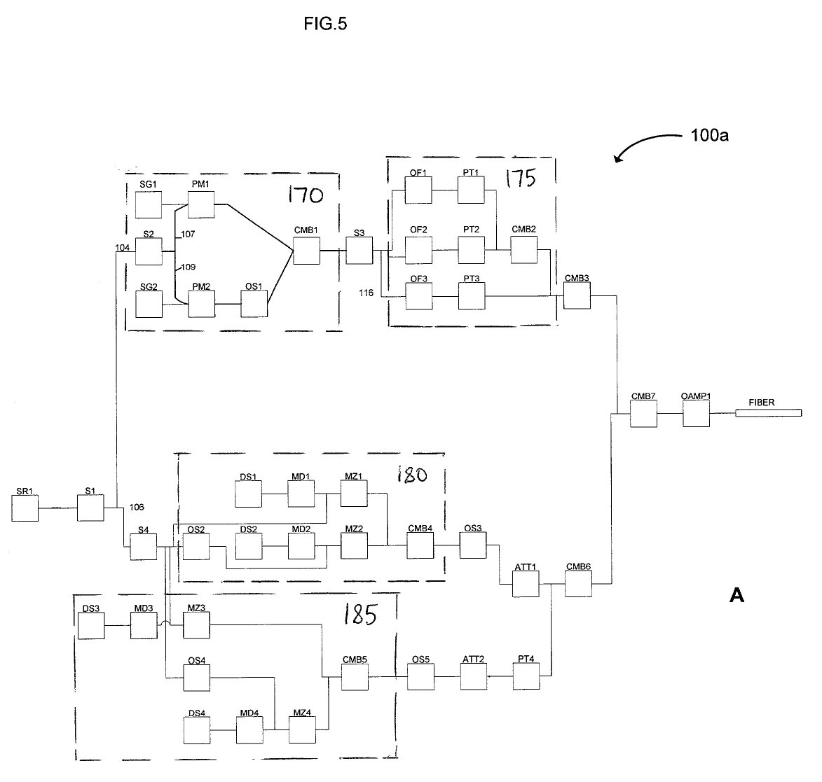

FIG. 5 shows an alternative embodiment of a transmitter 100a according to the present invention. In this embodiment, a single coherent radiation source SR1 at F_{SR1-A} transmits a signal to a splitter S1 which feeds an optical carrier generator 170 and a further splitter S4 which in turn feeds upper data modulator 180 and lower data modulator 185. The optical carrier generator 170, which can be implemented using a Mach-Zehnder interferometer, outputs carrier signals at −30 GHz, 0 GHz and +30 GHz with respect to the source frequency f_{SR1-A} at CMB1. This output is split at S3 and fed through a filtering section 175 including three narrow-band filters OF1, OF2 and OF3 which split the signal into three distinct signals at −30, 0 and +30 GHz relative to the source frequency. Each signal is passed to respective polarization transformers PT1, PT2 and PT3. PT1 gives x polarization to the −30 GHz signal, PT2 gives both x and y polarization to the 0 GHz signal and PT3 gives y polarization to the +30 GHz signal. The 0 GHz signal function is for pre-biasing the I-Q constellation position and it is optional. These signals are combined in CMB2 and CMB3.

In both the upper and lower data modulators 180,185 data signal generators DS1, DS2, DS3 and DS4 generate 10 Gbp/s data streams. In both data modulators 180, 185, data imprinted onto the source frequency optical carrier at f_{SR1-A} in quadrature and in x polarization. The data modulation is accomplished with similar interferometer and optical shifter components as described above with respect to the first embodiment. The output of the upper data modulator 180 at combiner CMB4 and the output of the lower data modulator 185 at combiner CMB5 are phase shifted in respective optical shifters OS3, OS5 and then attenuated in ATT1, ATT2. These components equalize the optical phase and magnitude of the outputs of the data modulators 180,185 before combining them for proper positioning or offset with respect to an in-phase and quadrature components. After being shifted and attenuated, the modulated signal from the lower data modulator 185 is transformed to y polarization by transformer PT4. The x-polarized signal from the upper data modulator 180 and the y polarized signal from the lower data modulator 180 are then combined in combiner CMB7 with the output from combiner CMB3. This signal is then amplified at OAMP1 and fed into a long-haul fiber.

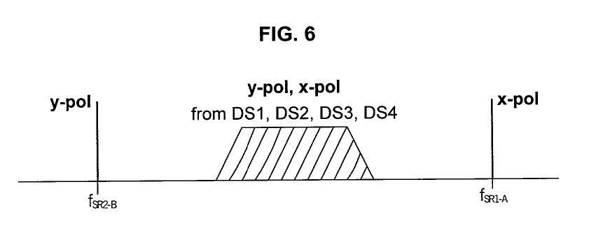

The spectrum of the output from CMB7 is shown in FIG. 6. The spectrum is identical to the spectrum shown in FIG. 4b. However, in the alternative embodiment, data is imprinted on the source carrier rather than on the derived side carriers at −30 and +30 GHz. This allows all information for one 40 Gbp/s WDM channel to be generated in one transmitter.

Both transmitter embodiments transmit data modulated optical signals having both x and y polarized orthogonal components along a long-haul optical fiber. While traveling down the fiber toward a receiver, the signals do not, in general, maintain their absolute x or y polarization. However, the relative orthogonal polarization between the signal components is maintained and therefore the data capacity of the transmitted signal is unaffected during transmission over the optical fiber. The side carriers, each having a different polarization, act as coded references for the portion of the data associated with each carrier.

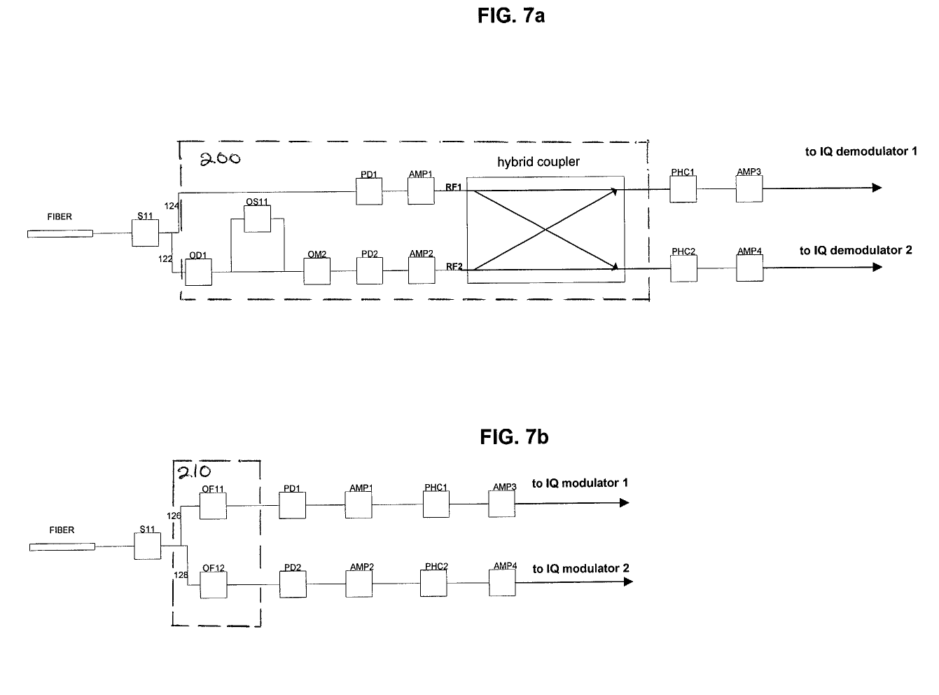

FIGS. 7a and 7b show two embodiments of a receiver according to the present invention. One embodiment, shown in FIG. 7a, performs polarization demultiplexing in the RF domain, while the other embodiment, shown in FIG. 7b, performs the polarization demultiplexing in the optical domain. In the first embodiment shown in FIG. 7a, the incoming signal is split at S11, into two branches 122,124, with each branch being input to a frequency differentiator 200. One branch 122 from splitter S11 is run through a demultiplexer OD1 whose first output takes −30 GHz to +10 GHz of bandwidth relative to the central frequency of the incoming signal and a second output that passes the optical carrier at +30 GHz relative to the central frequency, f_{SR1-A}, of the incoming signal. The first output therefore passes one of the side carriers (at f_{SR2-B}) and the central data band. The second output is optically phase shifted 180 degrees at optical shifter OS11 and then inserted into multiplexer OM2. The multiplexer combines the shifted signal with the remaining non-shifted sub-branch from OD1 which contains the data band and the side carrier at −30 GHz. Each branch 122, 124 is input to 40 GHz bandwidth photodiodes PD1, PD2, which convert the optical signals into intermediate frequency RF signals RF1 and RF2, with the information-carrying portions occupying the 20-40 GHz range. Because the data portion lies within an octave, i.e., the upper limit, 40 GHz, is equal to twice the lower limit of 20 GHz, second order distortions generated during transmission over the long haul fiber fall out of the 20-40 GHz range in the mixing process performed by the photodiodes PD1 and PD2. The 20-40 GHz range output from PD1 and PD2 is then amplified in AMP1 and AMP2 respectively.

RF1 contains the amplified output from the photodiode PD1 and includes a sum of products of one side carrier at F_{SR1-A} and associated data in x polarization, denoted S1, and products of the other side carrier at f_{SR2-B} and associated data in y polarization, denoted S2. Thus, RF1 can be written as S1+S2. RF2 includes the upper side carrier and data band, and the product of the lower side carrier and data band, and can therefore be written as S1−S2. When the RF1 and RF2 signals are input to a hybrid coupler as shown in FIG. 7a, a sum signal RF1+RF2 and a difference signal RF1 RF2 are created. RF1+RF2 is equal to (S1+S2)+(S1−S2)=2*S1, while RF1−RF2. is equal to (S1+S2)−(S1−S2)=2*S2. As noted above, S1 contains the data generated by both DS1 and DS2 in x-polarization and S2 contains data generated by both DS3 and DS4 in y polarization. Separation of polarization-multiplexed data is thereby achieved in the RF domain. The RF1−RF2 and RF1+RF2 signals are compensated for fiber-related dispersion effects in phase correctors PHC1 and PHC2. Each signal is input to an amplifier AMP3, AMP4 which boost the 20-40 GHz information band. Thereafter, the signals are downconverted to baseband in IQ demodulators, resulting in the four original baseband data signals generated by data signal generators DS1, DS2, DS3 and DS4.

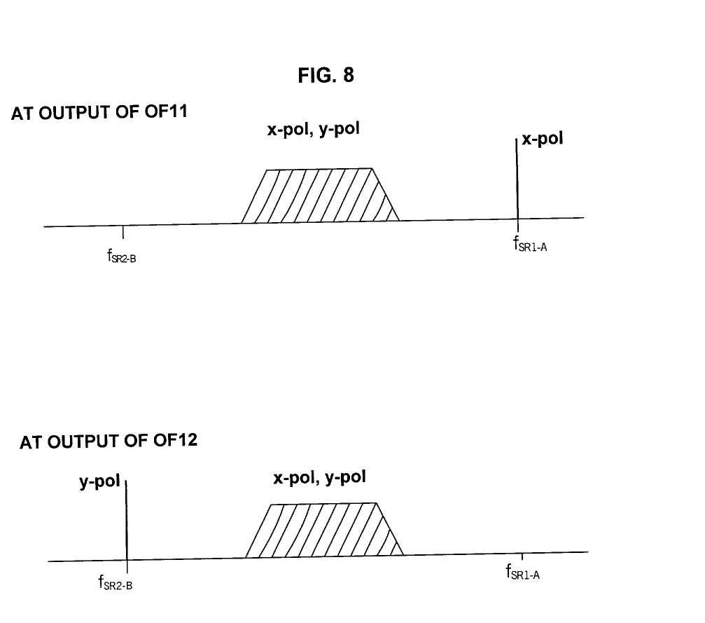

FIG. b shows a second embodiment of a receiver according to the present invention. The optical data signal from the fiber is split at S11 and each branch is passed to an optical frequency differentiator 210 which includes optical filters OF11, OF12, which may be, for example, Fabry-Perot filters. Each filter suppresses one of the polarization-coded side carriers, so that the data associated with the carrier and polarization can no longer be retrieved. After filtration, branch 126 contains signal S1 and branch 128 contains signal S2. FIG. 8 shows the spectra at the outputs of OF11 and OF12. Although by filtration half of the power of the data signals are lost, suppression of one carrier effectively separates DS1 and DS2 from DS3 and DS4. The filtered signals are converted to the RF domain in PD1, PD2, amplified and phase-corrected in PHC1 and PHC2. Thereafter, the data band of each signal is amplified and downconverted to baseband.

In the foregoing description, the method and system of the invention have been described with reference to a number of examples that are not to be considered limiting. Rather, it is to be understood and expected that variations in the principles of the method and apparatus herein disclosed may be made by one skilled in the art and it is intended that such modifications, changes, and/or substitutions are to be included within the scope of the present invention as set forth in the appended claims. For example, although only a 10 Gbp/s digital baseband is discussed, the inventive principles herein may be applied to higher data rates as the case may be.

What is claimed is:

1. An optical data signal transmitter comprising:
at least one optical carrier generator, each generating an optical carrier signal having two side frequencies derived from a source frequency;
at least one data modulator for modulating data onto the at least one optical carrier signal, creating at least one optical data signal including modulated data and having a first polarization state; and
at least one polarization transformer for encoding a portion of the modulated data and a first of the two side frequencies of the at least one optical data signal with a second polarization state, the second polarization state being orthogonal to the first polarization state.

2. The optical data signal transmitter of claim 1, wherein the at least one data modulator modulates data onto information bands, each information band centered at one of the two side frequencies of the at least one optical carrier signal respectively.

3. The optical data signal transmitter of claim 2, further comprising:
at least two optical source signal generators, a first source signal generator producing a first source frequency, a second source signal generator producing a second source frequency, each source frequency being transmitted to one of the at least one optical carrier generators, resulting in first and second optical carrier signals;
a plurality of data signal generators, the signals generators each transmitting a data signal at a data rate to a data modulator, each modulator modulating a pair of data signals in quadrature onto the first optical carrier signal, resulting in a first optical data signal and modulating a different pair of data signals in quadrature onto the second optical carrier signal, resulting in a second optical data signal; and
at least one phase shifter coupled to a data modulator, the at least one phase shifter modifying a phase of one of the pair of data signals modulating the first optical carrier signal, and one of the pair of data signals modulating the second optical carrier signal.

4. The optical data signal transmitter of claim 3, wherein the first and second source frequencies are separated by at least 50 GHz.

5. The optical data signal transmitter of claim 4, wherein the at least one polarization transformer changes one of the first and second data optical data signals from a first polarization state to a second polarization state.

6. The optical data signal transmitter of claim 5, wherein the two side frequencies of the optical carrier signal are located at least three times the data rate in GHz above and below the source frequency.

7. The optical data signal transmitter of claim 6, wherein the at least one optical carrier generator includes a Mach-Zehnder interferometer.

8. The optical data signal transmitter of claim 5, further comprising:
at least one optical combiner coupled to a source signal generator and at least one data modulator, the at least one optical combiner combining an optical data signal with a source frequency, the optical combiner outputting a combined signal, the combined signal including two information bands at side frequencies and the source frequency, the source frequency occupying a central frequency between the two information bands.

9. The optical data signal transmitter of claim 8, further comprising:
an optical multiplexer coupled to at least one optical combiner, the optical multiplexer multiplexing a first combined signal having a first polarization state and a first source frequency with a second combined signal having a second polarization state and a second source frequencies;
wherein the optical multiplexer filters out information bands, and passes only an information band occupying a frequency range in between the first and second original source frequencies, the information band after multiplexing including data from both the first and second combined signals.

10. The optical data signal transmitter of claim 1, wherein the at least one optical carrier generator produces an optical carrier signal that includes the source frequency and the at least one data modulator imprints data onto an information band centered at the source frequency.

11. The optical data signal transmitter of claim 10, further comprising:
a plurality of optical filters coupled to an optical carrier signal generator;
wherein an optical carrier signal is passed to the plurality of filters, the filters separating component frequencies of the carrier signal and outputting three carrier sub-signals, a first sub-signal including one side frequency, a second sub-signal including the source frequency and a third sub-signal including another side frequency, each sub-signal being transmitted to a different one of the at least one polarization transformers, the first sub-signal being transformed to a first polarization state, the second sub-signal being transformed to a first and a second polarization state, and the third sub-signal being transformed to a second polarization state, the first, second and third sub-signals being combined into a modified optical carrier signal.

12. The optical data signal transmitter of claim 11, further comprising:
a source signal generator, the source signal generator producing a source signal having the source frequency; and
a plurality of data signal generators;
wherein the plurality of data signal generators each transmit a data signal to at least one data modulator, the at least one data modulator modulating pairs of the plurality of data signals in quadrature onto the source signal transmitted by the source signal generator, at least one modulated pair being output as a first optical data signal having a first polarization state, at least one further modulated pair being output as a second optical data signal, the second data signal being transmitted to a polarization transformer which alters the second optical data signal to a second polarization state.

13. The optical data signal transmitter of claim 12, further comprising:
at least two optical combiners, each combiner coupled to one of the at least one data modulators and one of the at least one polarization transformers;
wherein a first optical combiner combines the first optical data signal with the second optical data signal and sends a combined signal to a second optical combiner where the combined signal is further combined with the modified optical carrier signal.

14. The optical data signal transmitter of claim 10, wherein the at least one optical carrier generator includes a Mach-Zehnder interferometer.

15. The optical data signal transmitter of claim 12, further comprising:
at least one optical phase shifter coupled to at least one data modulator; and
at least one attenuator coupled to the at least one phase shifter;
wherein the at least one optical phase shifter equalizes phases of the first and second optical data signals, and the at least one attenuator equalizes amplitudes of the first and second optical data signals.

16. A method of increasing the data capacity of optical transmission, comprising the steps of:
generating at least one optical carrier signal, each signal having two side frequencies derived from a source frequency;
modulating data onto the at least one optical carrier signal, creating at least one optical data signal including modulated data and having a first polarization state; and
encoding a portion of the modulated data and a first of the two side frequencies of the at least one optical data signal with a second polarization state, the second polarization state being orthogonal to the first polarization state.

17. The method of claim 16, wherein the step of modulating data onto the at least one optical carrier signal includes imprinting data onto information bands, each of the information bands centered at one of the two side frequencies.

18. The method of claim 17, wherein data is modulated onto the at least one optical carrier signal in quadrature.

19. The method of claim 17, further comprising the steps of:
inputting first and second coherent optical source signals having respective first and second source frequencies;
generating a first optical carrier signal from the first source signal and a second optical carrier signal from the second optical source signal;
modulating each of the first and second optical carrier signals with two data signals in quadrature, the data signals having a data rate;
outputting first and second optical data signals having a first polarization state;
transforming the polarization of the second optical data signal to a second polarization state; and
multiplexing the first and second optical data signals.

20. The method of claim 19, wherein the first optical source frequency is at least 50 GHz apart from the second source frequency, and the two side frequencies of the optical carrier signal are located three times the data rate in GHz above and below the source frequency.

21. The method of claim 16, wherein the optical carrier signal includes the source frequency and data is imprinted onto information band centered at the source frequency.

22. An optical receiver, comprising:
an optical splitter for splitting an incoming optical data signal into a first optical data sub-signal and a second optical data sub-signal, each of the sub-signals including a first side carrier frequency having a first polarization state, a second side carrier frequency having a second polarization state, and a central information band, the central information band including first data having the first polarization state and second data having the second polarization state; and
a frequency differentiator, the differentiator acting on the first and second side carrier frequencies differently, enabling the first side carrier frequency and the first data to be separated from the second side carrier frequency and the second data.

23. The optical receiver of claim 22, further comprising:
an optical arrangement for receiving the second optical data sub-signal and separating the first side carrier frequency and first data into a separated first signal and the second side carrier frequency and second data into a separated second signal, the arrangement changing the phase of the separated first side carrier frequency by 180 degrees, and recombining the shifted separated first signal with the separated second signal into a modified optical data signal; and
a hybrid coupler connected to the optical arrangement and the splitter, the hybrid coupler receiving RF-converted versions of the first sub-signal from the splitter and the modified optical data signal from the optical arrangement, the coupler generating sum and difference products, the sum product including an RF converted version of the first side carrier frequency and first data, and the difference product including an RF converted version of the second side carrier frequency and second data.

24. The optical receiver of claim 23:
wherein the optical arrangement includes:
an optical demultiplexer;
an optical shifter coupled to the optical demultiplexer; and
an optical multiplexer coupled to both the optical demultiplexer and the optical shifter.

25. The optical receiver of claim 24, further comprising:
at least two optoelectric converters for converting the optical data sub-signals from the optical domain to the RF domain.

26. The optical receiver of claim 22, further comprising:
two optical filters, each coupled to and receiving an optical data sub-signal from the splitter, the first optical data sub-signal being received by a first optical filter, the second sub-signal being received by a second optical filter, the first filter attenuating the second side carrier frequency and the second data and the second filter attenuating the first side carrier frequency and the first data.

27. The optical receiver of claim 22, further comprising:
an optical filter that separates an optical data sub-signal into two signals, a first signal including a first data band and the first side carrier frequency and the second signal including a second data band and the second side carrier frequency.

28. The optical receiver of claim 27, wherein the first data band of the first signal is attenuated with respect to the first side carrier frequency and the second data band of the second signal is attenuated with respect to the second side carrier frequency.

29. The optical receiver of claim 27, wherein the optical filter demultiplexes an optical data sub-signal into a plurality of input signals, each input signal having different frequencies.

30. The optical receiver of claim 29, wherein the optical filter includes a Fabry-Perot filter, the Fabry-Peror filter having repetitive frequency response.

31. An optical data communication system, comprising:
an optical data signal transmitter, including:
at least one optical carrier generator, each generating an optical carrier signal having two side frequencies derived from a source frequency;
at least one data modulator for modulating data onto the optical carrier signal, creating an optical data signal including modulated data and having a first polarization state; and
at least one polarization transformer for encoding a portion of the modulated data and a first of the two side frequencies of the at least one optical data signal with a second polarization state, the second polarization state being orthogonal to the first polarization state;
an optical fiber for carrying the optical data signal; and
an optical receiver for receiving the optical data signal.

32. The optical data communication system of claim 31, wherein the optical receiver includes:
an optical splitter for splitting an incoming optical data signal into a first optical data sub-signal and a second optical data sub-signal, each of the sub-signals including a first side carrier frequency having a first polarization state, a second side carrier frequency having a second polarization state, and a central information band, the central information band including first data having the first polarization state and second data having the second polarization state; and
a frequency differentiator, the differentiator acting on the first and second side carrier frequencies differently, enabling the first side carrier frequency and the first data to be separated from the second side carrier frequency and the second data.

33. A method for enhancing data capacity in optical data communication, comprising the steps of:
modulating first data onto a first optical carrier onto a data band occupying a data frequency range, the first optical carrier including a first side frequency separated from the frequency range of the data band, resulting in a first modulated carrier having a first polarization state;
modulating second data onto a second optical carrier onto a data band occupying the data frequency range, the second optical carrier including a second side frequency separated from the data frequency range of the data band in a direction opposite from the first side frequency, resulting in a second modulated carrier having a first polarization state;
changing the polarization state of the second modulated carrier to a second polarization state orthogonal to the first polarization state;
combining the first modulated carrier with the second modulated carrier into a combined carrier;
optically transmitting the combined carrier;
receiving the transmitted carrier; and
extracting the first data having the first polarization state from the second data having the second polarization state.

34. The method of claim 19, further comprising the step of:
filtering the multiplexed signal to pass a portion of the multiplexed signal having frequencies located between the first and second source frequencies.
